(19) United States
(12) Patent Application Publication
(10) Pub. No.: US 2006/0055261 A1
(43) Pub. Date: Mar. 16, 2006

(54) Multiple stator charging system

(76) Inventor: James M. Walker, Fond du Lac, WI (US)

Correspondence Address: GODFREY & KAHN S.C., 780 NORTH WATER STREET, MILWAUKEE, WI, 53202, US

(21) Appl. No.: 11/228,628

(22) Filed: Sep. 16, 2005

Related U.S. Application Data
(60) Provisional application No. 60/611,043, filed on Sep. 16, 2004.

(51) Int. Cl. H02K 7/00; H02K 7/02; H02K 47/00

(52) U.S. Cl. 310/112; 310/74; 310/156.26; 310/67 R

(57) ABSTRACT

A charging system comprising a rotor with at least two rows of magnets affixed to the inside surface of the sidewall of the rotor and at least two stators connected in parallel or in series with each stator having a plurality of pole pairs and the rotor having a plurality of magnet pole pairs.

### CROSS-REFERENCE TO RELATED APPLICATIONS

This application is based on and claims the benefit of U.S. Provisional Patent Application No. 60/611,043, filed on Sep. 16, 2004, which is incorporated herein by reference.

### BACKGROUND OF THE INVENTION

The present invention relates generally to a charging system for an internal combustion engine, and more particularly to a permanent magnet multiple stator charging system for a small internal combustion engine.

The electrical system of a small internal combustion engine typically comprises a charging system. The charging system is responsible for keeping the battery charged, starting the engine and powering the electrical accessories on a vehicle. When the engine starts running, the charging system takes over. The charging system becomes responsible for supplying energy to all of the loads on the vehicle when the engine is running and recharging the battery. If the electrical system does not include a battery, the charging system operates like a generator (magneto), generating AC power as long as the engine is running. If the system includes a battery, a rectifier is coupled to the charging system to convert AC power to DC power so that it can be stored in the battery and used to supply power to accessories even when the engine is not running.

A magneto-type charging system for a small internal combustion engine typically comprises a rotor with magnets charged to any number of pole pair configurations, a stator comprising copper or aluminum wire wound on a magnetic material with a number of poles that coincide with the poles of the rotor, a voltage regulator assembly that is used to control the output voltage and current of the charging system.

The stator and rotor are mounted to the crankshaft of the engine within the crankcase of the engine. The stator generally includes a plurality of windings wound around a plurality of poles extending outwardly from a central core. The stator is preferably mounted under the rotor with the rotor having a plurality of magnets mounted to the inside surface of the sidewall of the rotor. Rotation of the rotor creates a magnetic field and induces a current in the windings of the stator for supplying electrical power to the vehicle.

As mentioned above, the charging system typically includes a rotor with magnets charged to any number of pole pair configurations, a stator comprising copper or aluminum wire wound on a magnetic material with a number of poles that coincide with the poles of the rotor, and a voltage regulator assembly that is used to control the output voltage and current of the rotor and stator of the internal combustion engine.

Accordingly, a need exists for an improved charging system that provides higher output current at a lower operating temperature in the same packaging envelope as prior art charging systems.

### SUMMARY OF THE INVENTION

The present invention provides a charging system comprising a rotor with a plurality of permanent magnets mounted to the inside surface of the sidewall of the rotor at equally spaced angular intervals. The magnets are circumferentially arranged and magnetized in the radial direction with alternating north and south polarities. The magnets are affixed to the inside surface of the rotor sidewall by an adhesive or other fastening means. The magnets are preferably arranged in at least two rows and affixed to the inside surface of the rotor sidewall by an adhesive or other fastening means. The at least two rows of magnets correspond with the poles of the at least two stators mounted within the rotor. The charging system also comprises at least two stators mounted under the rotor. The stators each include a central core with a plurality of poles extending outwardly from the periphery of the core. The poles each having a radially extending member extending outwardly from the central core and an end member located at the end of the radially extending member. At least one length of wire is wound around the radially extending members of the poles of the stators to comprise windings. The charging system includes two or more stators with windings connected in parallel or in series. The charging system of the present invention takes up the same amount of area as prior art charging systems. An air gap exits between the end members and the magnets to allow rotation of the rotor around the stators. Rotation of the rotor around the stators creates a changing magnetic field in the stators poles and induces a current in the windings of the stators. A plurality of wires are connected to the stators windings providing outputs for connection to other electrical components of the charging system.

The stators of the charging system can comprise a plurality of different pole configurations, including different numbers of poles, different lengths of poles, and axially and/or radially extending poles.

The charging system of the present invention may be incorporated into a plurality of different power equipment and/or vehicles that require battery charging and/or electrical power generation, such as ATVs, lawn mowers, motorcycles, personal watercrafts, snowmobiles, power generators, etc.

The charging system also provides a higher current output and a lower operating temperature. All the while keeping the charging system in the same size envelope as current prior art charging systems and providing a multiple number of stator poles and magnet poles. The charging system of the present invention provides for an easier and quicker assembly of the vehicle, resulting in a cost savings of material and labor, reducing the labor and costs associated with manufacturing a permanent magnet charging system.

Various other features, objects, and advantages of the invention will be made apparent to those skilled in the art from the following detailed description, claims, and accompanying drawings.

### BRIEF DESCRIPTION OF THE DRAWINGS

FIG. 1 is a top view of a rotor in accordance with an embodiment of the present invention;

FIG. 2 is a bottom view of the rotor of FIG. 1;

FIG. 3 is a side view of the rotor of FIG. 1;

FIG. 4 is a perspective view of the rotor of FIG. 1;

FIG. 5 is a top view of a multiple stator assembly in accordance with an embodiment of the present invention;

FIG. 6 is an enlarged top view of the multiple stator assembly of FIG. 5;

FIG. 7 is a side view of the multiple stator assembly of FIG. 5;

FIG. 8 is a bottom view of the multiple stator assembly of FIG. 5;

FIG. 9 is a perspective view of the multiple stator assembly of FIG. 5;

FIG. 10 is another side view of the multiple stator assembly of FIG. 5; and

FIG. 11 is still another side view of the multiple stator assembly of FIG. 5.

### DETAILED DESCRIPTION OF THE INVENTION

The charging system of the present invention preferably includes a rotor with a plurality of permanent magnets mounted to the inside surface of the sidewall of the rotor at equally spaced angular intervals. The magnets are circumferentially arranged and magnetized in the radial direction with alternating north and south polarities. The magnets are affixed to the inside surface of the rotor sidewall by an adhesive or other fastening means. The charging system also comprises at least two stators mounted under the rotor. The stators each include a central core with a plurality of poles extending outwardly from and circumferentially arranged around the central core. The poles are preferably spaced-apart with the same polar pitch as the magnets. The poles each having a radially extending member extending outwardly from the central core and an end member located at the end of the radially extending member. Each end member having a length larger than the width of the radially extending member. A plurality of windings are wound around the radially extending members of the poles of the stators. At least one length of wire is wound around the radially extending members of the poles of the stators to comprise windings. An air gap exits between the end members and the magnets to allow rotation of the rotor around the stators. Rotation of the rotor and the plurality of permanent magnets mounted to inside surface of the rotor's sidewall around the stators creates a changing magnetic field in the stators poles and induces a current in the windings of the stators.

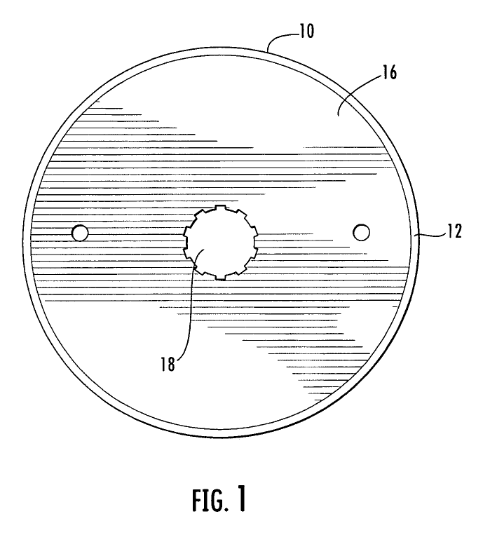

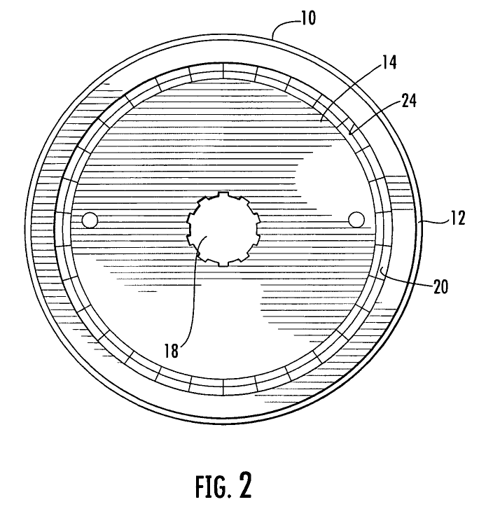

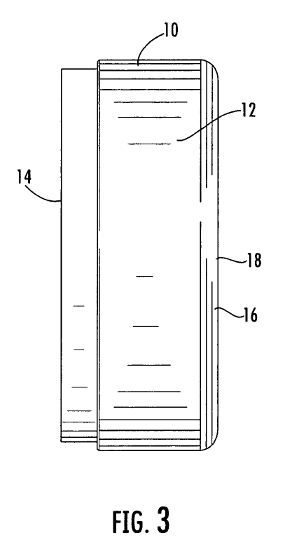

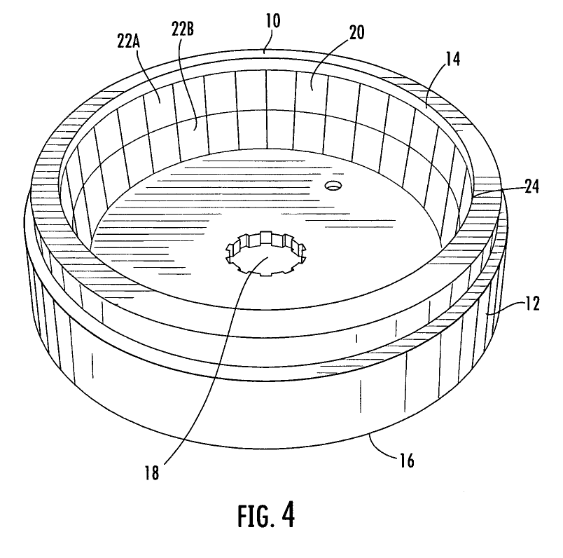

Referring now to the drawings, FIGS. 1-4 are various views of a rotor 10 in accordance with an embodiment of the present invention. The rotor 10 preferably includes a sidewall 12 with an open end 14 at one end thereof and a closed end 16 at the opposite end thereof. The closed end 16 preferably includes at least one opening 18 extending therethrough for mounting the rotor to a crankshaft of an internal combustion engine. The crankshaft is coupled to and responsible for rotating the rotor while the engine is running. The rotor 10 also preferably includes a plurality of magnets 20 charged to any number of pole pair configurations. The magnets 20 are preferably arranged in at least two rows 22A, 22B affixed to the inside surface 24 of the rotor sidewall 12 by an adhesive or other fastening means. The at least two rows 22A, 22B of magnets 20 correspond with the poles of the at least two stators mounted within the rotor 10.

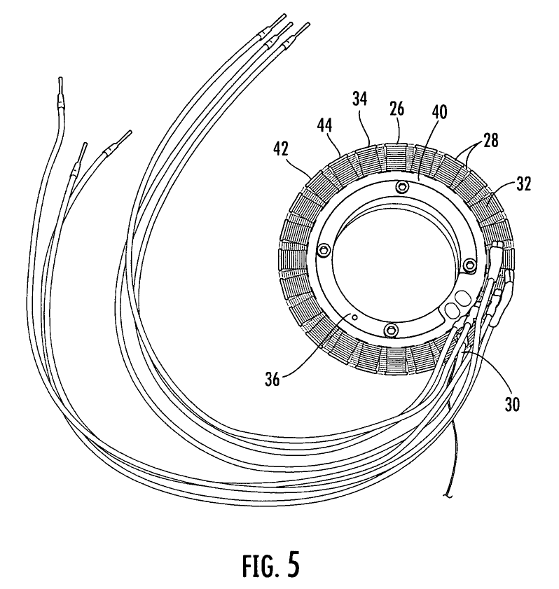

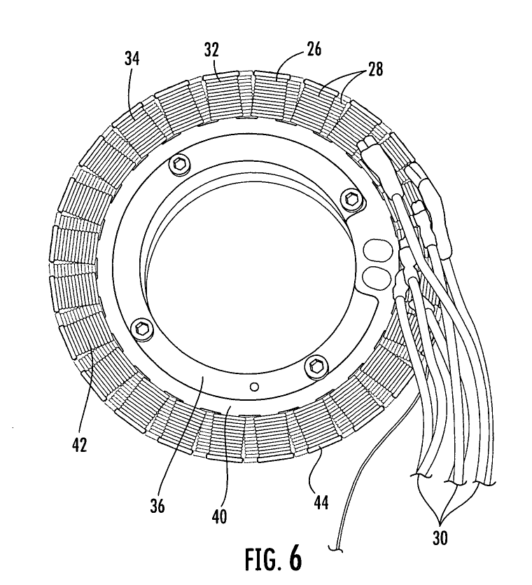

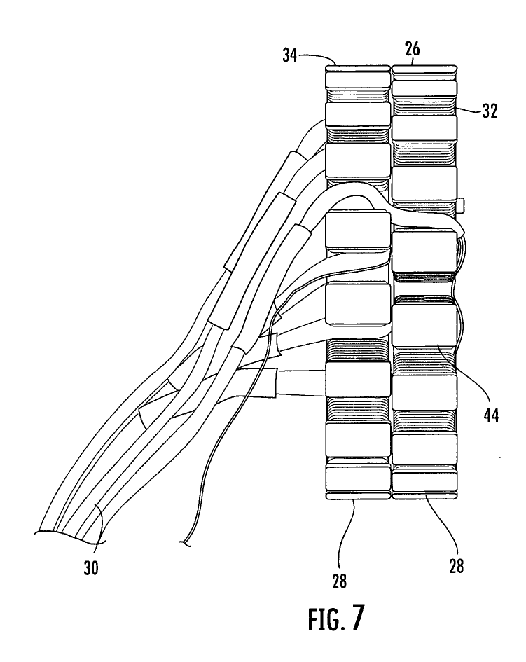

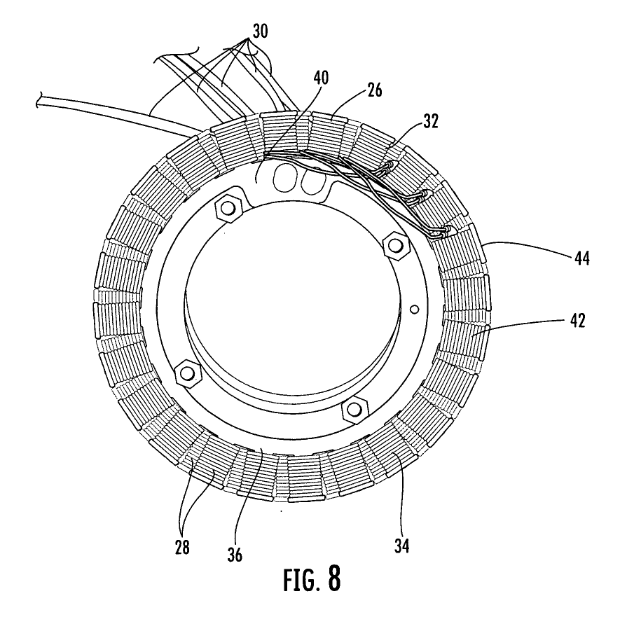

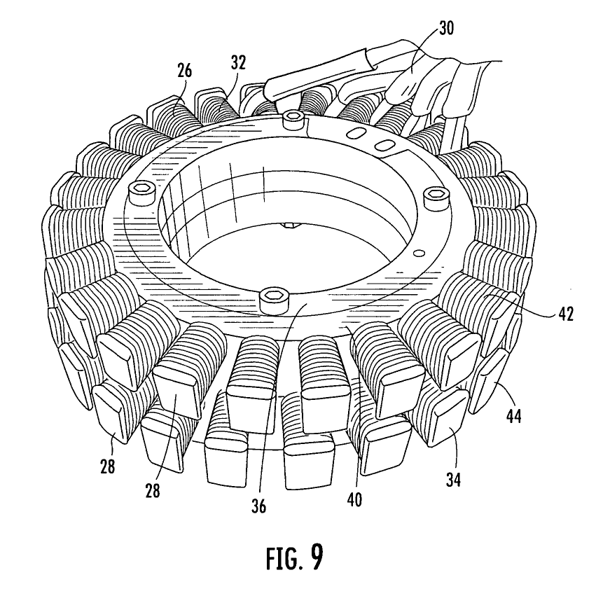

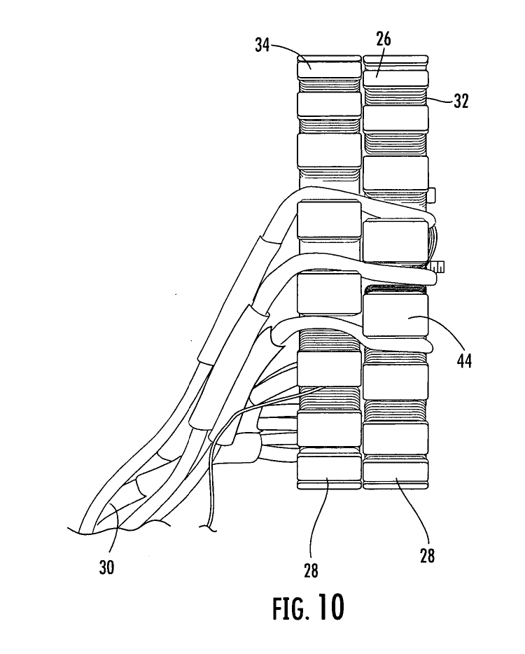

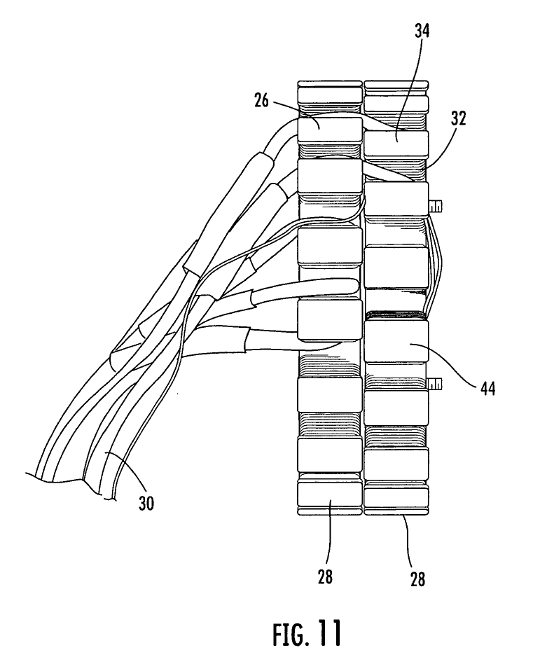

FIGS. 5-11 are various views of a multiple stator assembly 26 in accordance with an embodiment of the present invention. The multiple stator assembly 26 comprises at least two stators 28 and a plurality of wires 30 coupled to windings 32 wound around the stator poles 34 for connection to other electrical components of the charging system. The multiple stator assembly 26 is preferably mounted on the engine crankcase with the rotor 10 mounted on the crankshaft above the multiple stator assembly 26. Each stator 28 of the multiple stator assembly 26 is preferably comprised of a stack of laminations that are affixed together. Each stator 28 preferably includes a central core 36 with a plurality of poles 34 extending outwardly from the periphery of the central core 36. The poles 34 are circumferentially arranged around the periphery of the central core 36. The periphery of the central core 36 and the poles 34 are preferably electrically insulated from the central core 36 by an insulating material 40. The poles 34 are preferably spaced-apart with the same polar pitch as the magnets 20. The poles 34 each have a radially extending member 42, extending outwardly from the central core 36 and an end member 44 located at the end of the radially extending member 42. The stators preferably include copper or aluminum wire wound on a magnetic material with a number of poles that coincide with the poles of the rotor. The at least two stators 28 may be fastened together with adhesive or other fastening means. The stators are usually mounted on a part of the engine crankcase in close proximity to the engine crankshaft for the rotor to be able to take advantage of the rotational movement of the crankshaft to generate the changing magnetic field required to produce an output in the stators. A plurality of windings 32 are wound around the radially extending members 42 of the poles 34 of each stator 28. At least one length of wire is wound around the poles 34 of each stator 28 to comprise the windings 32. The stator windings 32 of the at least two stators 28 are connected in parallel or in series. A plurality of wires 30 are connected to and extend from the windings 32 for connection to other electrical components of the charging system. The stators 28 can comprise a plurality of different pole configurations, including different numbers of poles, different lengths of poles, and axially and/or radially extending poles. Therefore, the stators 28 of the present invention can have any number of poles, poles of different lengths, and axially and/or radially extending poles.

With the multiple stator assembly 26 mounted within the rotor 10 of the charging system, an air gap 46 exits between the end members 44 and the magnets 20 to allow rotation of the rotor 10 around the stators 28. Rotation of the rotor 10 and the plurality of permanent magnets 20 mounted to inside surface 26 of the rotor's sidewall 12 around the stators 28 creates a magnetic field and induces a current in the windings 32 of the stators 28. The charging system of the present invention fits into the same size envelope area as prior art charging systems.

The charging system of the present invention provides many advantages over the prior art. Some of these advantages include the following. 1) The ability to provide higher output currents than prior art charging systems. 2) The increase in the number of magnet poles increases the frequency of the changing magnetic field which helps to limit the current to lower values at higher engine RPMs. 3) Increasing the magnet frequency also allows for fewer turns of wire on the stators. 4) Fewer windings on the stators allow for larger wire gauges to be used on the windings of the stators, helping to reduce operating temperatures. 5) Fewer windings on the stators allow the stators to be manufactured at a lower cost. 6) Lower torque is required for rotation of the rotor when increasing the pole count. 7) Lower operating temperatures of the charging system provide for a more reliable charging system. 8) When using rare earth magnets, the number of laminations for the stators can also be reduced by increasing the number of magnet poles. 9) Increasing the number of magnet poles can be done with all types of magnetic materials, including Ceramic, Neodymium, Samarium-Cobalt and Alnico.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A charging system comprising:
a rotor with a plurality of permanent magnets mounted to an inside surface of a sidewall of the rotor;
at least two stators mounted within the rotor, the at least two stators each including a central core with a plurality of poles extending radially outwardly from the periphery of the core, the poles each having a radially extending member extending outwardly from the central core and an end member located at the end of the radially extending member;
a plurality of coil windings wound around each of the radially extending members of the at least two stators;
an air gap between the end members and the magnets to allow rotation of the rotor around the at least two stators creating a magnetic field and inducing a current in the windings of the at least two stators; and
a plurality of wires connected to and extending from the coil windings for connection to other electrical components of the charging system.

2. The charging system of claim 1 wherein the plurality of magnets are arranged in at least two rows affixed to the inside surface of the rotor sidewall.

3. The charging system of claim 1 wherein the at least two stators windings are connected in parallel.

4. The charging system of claim 1 wherein the at least two stators windings are connected in series.

5. The alternator of claim 1 wherein the increase in the number of stator poles and magnet poles results in higher outputs and lower operating temperatures of the charging system making the charging system more efficient and reliable.

6. A charging system for an internal combustion engine comprising:
a rotor mounted to a crankshaft of the engine within a crankcase of the engine, the rotor having at least two rows of magnets affixed to an inside surface of a sidewall of the rotor and charged to any number of pole par configurations; and
at least two stators mounted to the crankshaft of the engine, the at least two stators having wire wound on a magnetic material with a number of poles that coincide with the magnet poles of the rotor.

7. The charging system of claim 6 wherein the at least two stators are mounted on the engine crankcase to be in close proximity to the engine crankshaft for the rotor to be able to take advantage of the rotational movement of the crankshaft to generate the changing magnetic field required to produce an output from the at least two stators.
